(19) United States
(12) Patent Application Publication
(10) Pub. No.: US 2019/0208188 A1
(43) Pub. Date: Jul. 4, 2019

(54) DISPLAY DEVICE AND CONTROL METHOD THEREOF

(71) Applicants: BOE TECHNOLOGY GROUP CO., LTD., Beijing (CN); ORDOS YUANSHENG OPTOELECTRONICS CO., LTD., Ordos, Inner Mongolia (CN)

(72) Inventors: Ning WANG, Beijing (CN); Wei LI, Beijing (CN); Pan GUO, Beijing (CN); Yanqing CHEN, Beijing (CN)

(21) Appl. No.: 16/096,144

(22) PCT Filed: Apr. 8, 2018
(86) PCT No.: PCT/CN2018/082174

§ 371 Date: Oct. 24, 2018

(30) Foreign Application Priority Data
Apr. 27, 2017 (CN) 201710289615.4

(51) Int. Cl. H04N 13/351; H04N 13/383; H04N 13/385

(52) U.S. Cl. CPC H04N 13/351; H04N 13/385; H04N 13/383

(57) ABSTRACT

Embodiments of the present disclosure provide a display device and a control method thereof. The display device includes a display unit, a light-adjusting structure, and a controller. The display unit may be configured to periodically display n images for different viewing angles in a time-division manner, the respective image for the respective viewing angle is displayed in one frame. The light-adjusting structure may be transformed into m different states, and may be configured to adjust, in the respective states, light emitted by the display unit to directions of different viewing positions. The controller is coupled to the light-adjusting structure and may be configured to control the light-adjusting structure to be periodically transformed into n different states to periodically direct the n images for the different viewing angles to n viewing positions.

### CROSS REFERENCE TO RELATED APPLICATIONS

This patent application is a National Stage Entry of PCT/CN2018/082174 filed on Apr. 8, 2018, which claims the benefit and priority of Chinese Patent Application No. 201710289615.4 filed on Apr. 27, 2017, the disclosures of which are incorporated herein by reference in their entirety as part of the present application.

### BACKGROUND

The present disclosure relates to the field of display technologies, and in particular, to a display device and a control method thereof.

At present, 3D display, with its real and vivid expressiveness, beautiful and elegant environmental appeal, and strong shocking visual impact, is favored by consumers.

Typically, viewers need to wear corresponding 3D glasses to view the 3D display. Therefore, the application of 3D display technology will be limited by places and equipment. The naked eye 3D display technology developed in recent years overcomes the constraints of special glasses, such that the naked eye 3D display has been widely concerned.

### BRIEF DESCRIPTION

Embodiments of the present disclosure provide a display device and a control method thereof.

A first aspect of the present disclosure provides a display device. The display device may include a display unit, a light-adjusting structure, and a controller. The display unit may be configured to periodically display n images for different viewing angles in a time-division manner, wherein the respective image for the respective viewing angle is displayed in one frame, wherein n is a positive integer and n≥2. The light-adjusting structure may be transformed into m different states, and the light-adjusting structure may be configured to adjust, in the respective states, light emitted by the display unit to directions of different viewing positions, wherein m is a positive integer and m>n. The controller is coupled to the light-adjusting structure and may be configured to control the light-adjusting structure to be periodically transformed into n different states to periodically direct the n images for the different viewing angles to n viewing positions.

In an embodiment of the present disclosure, the light-adjusting structure includes a plurality of light-adjusting units arranged in a dot array.

In an embodiment of the present disclosure, the light-adjusting unit is a microlens. The microlens rotates under the control of the controller.

In an embodiment of the present disclosure, the controller includes a rotation unit, a signal transmission unit, and a processing unit. The rotation unit is fixedly coupled to the microlens and may be configured to control the rotation of the microlens. The signal transmission unit may be configured to transmit pulse signals having different widths. The processing unit is coupled to the signal transmission unit and the rotation unit, and may be configured to process the pulse signal into a control signal for controlling a direction of rotation and an angle of rotation of the rotation unit.

In an embodiment of the present disclosure, the display unit includes a projection device and an image source. The image source is configured to provide image information to the projection device. The projection device is coupled to the image source and may be configured to project the image information provided by the image source onto the light-adjusting structure.

In an embodiment of the present disclosure, the display device may further include a human eye position recognizer. The human eye position recognizer may be configured to acquire a human eye position.

In an embodiment of the present disclosure, the n images for different viewing angles include n/2 sets of a left eye image and a right eye image displayed in adjacent frames. The left eye image and the right eye image in each set are respectively directed to the left eye viewing position and the right eye viewing position of the same viewer. n is an integer multiple of 2.

In an embodiment of the present disclosure, the light-adjusting structure may be disposed on a light-existing side of the display unit.

In an embodiment of the present disclosure, the display unit may be disposed around the light-adjusting structure, and the light emitted by the display unit may be incident on the light-adjusting structure.

In an embodiment of the present disclosure, the light-adjusting structure may include a liquid crystal component.

In an embodiment of the present disclosure, the light-adjusting structure may include a plurality of strip-shaped light-adjusting units arranged in sequence in a horizontal direction.

In an embodiment of the present disclosure, a number of the light-adjusting units may be the same as a resolution of the image displayed by the display unit.

In an embodiment of the present disclosure, the rotation unit may be disposed on each of the microlenses, and the signal transmission unit and the processing unit may be disposed on each of the microlenses, or a plurality of the signal transmission units and the processing unit may be integrated together.

A second aspect of the present disclosure provides a method for controlling a display device. The method includes controlling a display unit to periodically display n images for different viewing angles in a time-division manner, wherein the respective image for the respective viewing angle is displayed in one frame, and periodically directing the n images for the different viewing angles to n viewing positions, wherein n is a positive integer and n≥2.

In an embodiment of the present disclosure, n is an integer multiple of 2, and the n images for the different viewing angles include n/2 sets of a left eye image and a right eye image displayed in adjacent frames. The method further includes acquiring a left eye viewing position and a right eye viewing position of the viewer, and respectively directing the left eye image and the right eye image in each set to the left eye viewing position and the right eye viewing position of the same viewer.

In an embodiment of the present disclosure, n is an integer multiple of 2, and the n images for the different viewing angles include n/2 sets of two same images displayed in adjacent frames. The method further includes acquiring a left eye viewing position and a right eye viewing position of the viewer, and respectively directing two same images in each set to the left eye viewing position and the right eye viewing position of the same viewer.

### BRIEF DESCRIPTION OF THE DRAWINGS

In order to more clearly illustrate the embodiments of the present disclosure or the technical solutions, the drawings to be used in the embodiments will be briefly described below. Obviously, the drawings in the following description merely pertain to certain embodiment of the present disclosure, and other drawings may be obtained from these drawings by those of ordinary skill in the art without any creative work.

FIG. 1 is a schematic structural diagram of a display device;

FIG. 2A is a schematic structural diagram of a display device according to an embodiment of the present disclosure;

FIG. 2B is a schematic structural diagram of a display device according to an embodiment of the present disclosure;

FIG. 3A is a schematic structural diagram of a light-adjusting structure directing an image for a certain viewing angle to a direction of a viewing position according to an embodiment of the present disclosure;

FIG. 3B is a schematic structural diagram of a light-adjusting structure directing an image for a certain viewing angle to a direction of a viewing position according to an embodiment of the present disclosure;

FIG. 4A is a schematic structural diagram of a light-adjusting structure according to an embodiment of the present disclosure;

FIG. 4B is a schematic structural diagram of a light-adjusting structure according to an embodiment of the present disclosure;

FIG. 4C is a schematic structural diagram of a light-adjusting structure according to an embodiment of the present disclosure;

FIG. 5 is a schematic diagram of changes of states of a microlens according to an embodiment of the present disclosure;

FIG. 6 is a schematic structural diagram of a display device according to an embodiment of the present disclosure;

FIG. 7 is a schematic structural diagram of a display device according to an embodiment of the present disclosure; and

FIG. 8 is a flow chart showing a method for controlling a display device according to an embodiment of the present disclosure.

### DETAILED DESCRIPTION

The technical solutions in the embodiments of the present disclosure are clearly and completely described in the following with reference to the accompanying drawings in the embodiments of the present disclosure. It is obvious that the described embodiments are only a part of the embodiments of the present disclosure, instead of all of the embodiments. All other embodiments obtained by a person of ordinary skill in the art based on the embodiments of the present disclosure without creative work fall within the scope of the present disclosure.

In the description of the embodiments of the present disclosure, unless otherwise stated, “a plurality” indicates two or more, the orientation or positional relationships indicated by the terms “upper”, “lower”, “left”, “right”, “inside”, or “outside” are based on the orientation or positional relationships shown in the drawings, and are merely for the convenience of describing the present disclosure and simplifying the description, rather than indicating or implying that the machine or component referred to must have a specific orientation, be constructed and operated in a specific orientation, and therefore shall not be construed as limiting the present disclosure.

In the description of the embodiments of the present disclosure, it can be noted that the term “installation”, “connection”, or “coupling” should be understood broadly, and may be a fixed connection, for example, or may be a detachable connection, or an integral connection, it may be a mechanical connection or an electrical connection, it may be a direct connection, or an indirect connection through an intermediate medium. The specific meaning of the above terms in the present disclosure may be understood in a specific case by those of ordinary skill in the art.

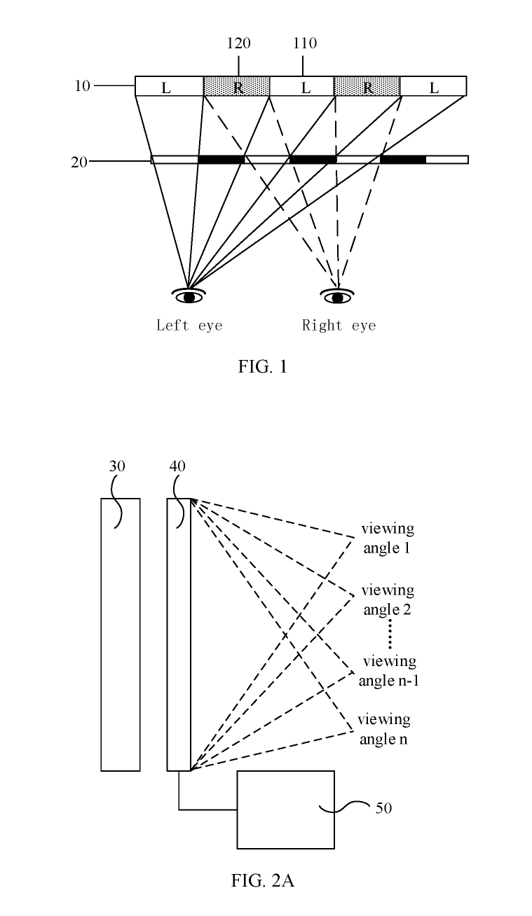

The related art naked eye 3D technology is mainly implemented in three ways, including light barrier type, cylindrical mirror type, and directional backlight type. However, taking the light barrier type as an example, as shown in FIG. 1, a naked eye 3D display device includes a display panel 10 and a grating 20. The display panel 10 includes left eye pixels 110 and right eye pixels 120. The left eye pixels 110 may only be seen by the left eye through the grating 20, and the right eye pixels 120 may only be seen by the right eye through the grating 20. As the left eye pixels 110 and the right eye pixels 120 are ½ of the display panel pixels respectively. Thus, the resolution of the image seen by the viewer may be lowered at the time of 3D display. Display principles of the cylindrical mirror type and the directional backlight type are the same with display principles of the light barrier type. In these cases, the resolution is reduced, such that user experience would be inversely affected.

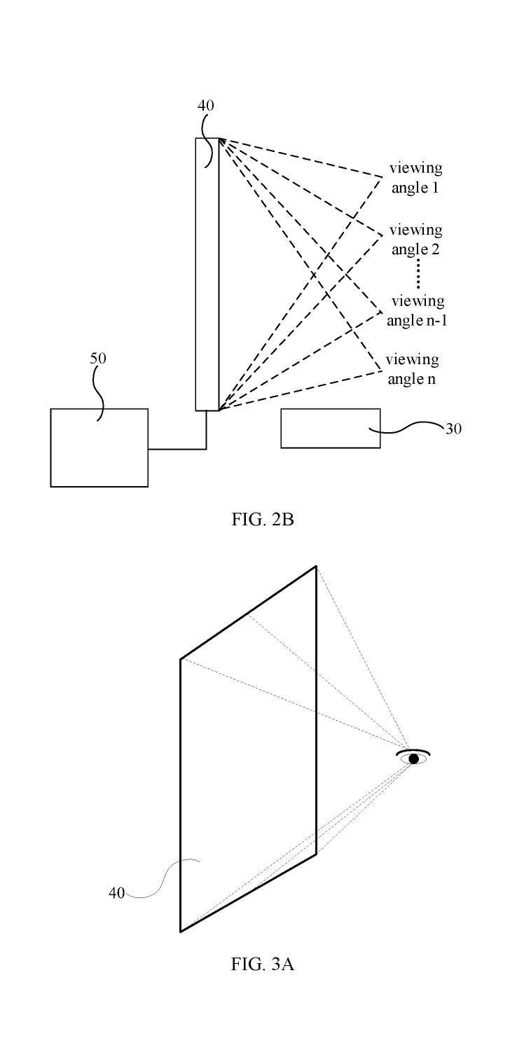

FIG. 2A illustrates a display device according to an embodiment of the present disclosure. The display device includes a display unit 30, a light-adjusting structure 40, and a controller 50.

Specifically, the display unit 30 may periodically display n images for different viewing angles in a time-division manner, wherein the respective image for the respective viewing angle is displayed in one frame, n≥2, and n is a positive integer. The light-adjusting structure 40 may be transformed into m different states. The light-adjusting structure 40 may adjust, in respective states, the light emitted by the display unit 30 to directions of different viewing positions, wherein m>n, m is a positive integer. The controller 50 may be coupled (connected) to the light-adjusting structure 40. The controller 50 may be configured to control the light-adjusting structure 40 to be periodically transformed into n different states to periodically direct the n images for different viewing angles to n viewing positions.

As shown in FIG. 2A, the light-adjusting structure 40 may be disposed on the light-existing side of the display unit 30, so that the light-adjusting structure 40 may adjust the light emitted from the display unit 30.

FIG. 2B shows a display device according to an embodiment of the present disclosure. As shown in FIG. 2B, the display unit 30 may be disposed around the light-adjusting structure 40, and the light emitted by the display unit 30 may be completely incident on the light-adjusting structure 40. Thereby, the light-adjusting structure 40 may adjust the light irradiated thereto. In addition, the display device in FIG. 2B is the same as the display device in FIG. 2A in terms of structure and functionality, and will not be described in detail.

It will be appreciated that the positions of the display unit 30 and the light-adjusting structure 40 may also be arranged according to other embodiments.

In the case where the n images for different viewing angles are directed to n viewing positions, since the image for each viewing angle has a one-to-one correspondence with the viewing position to which the image for the viewing angle is directed, the change in the image displayed by the display unit 30 is supposed to be synchronized with and have a one-to-one correspondence with the change in the state of the light-adjusting structure 40. For example, in response to the display unit 30 displaying an image for a first viewing angle, the state of the light-adjusting structure 40 is that the direction of the light emitted by the display unit 30 may be adjusted to a direction of a viewing position corresponding to the first viewing angle, to provide the viewing position with an image corresponding to the first viewing angle. In response to the display unit 30 displaying an image of a second viewing angle, the state of the light-adjusting structure 40 is changed synchronously, and the light-adjusting structure 40 may adjust the direction of the light emitted by the display unit 30 to a direction of the viewing position corresponding to the second viewing angle, and so on, which will not be further described in detail herein.

In an embodiment of the present disclosure, the type of the light-adjusting structure 40 is not limited, as long as the state of the light-adjusting structure 40 may be changed and the light-adjusting structure 40 may adjust, in the respective states, the light emitted by the display unit 30 to be directed to different directions. The light-adjusting structure 40 may be, for example, a liquid crystal component, or may be a plurality of microlenses or the like.

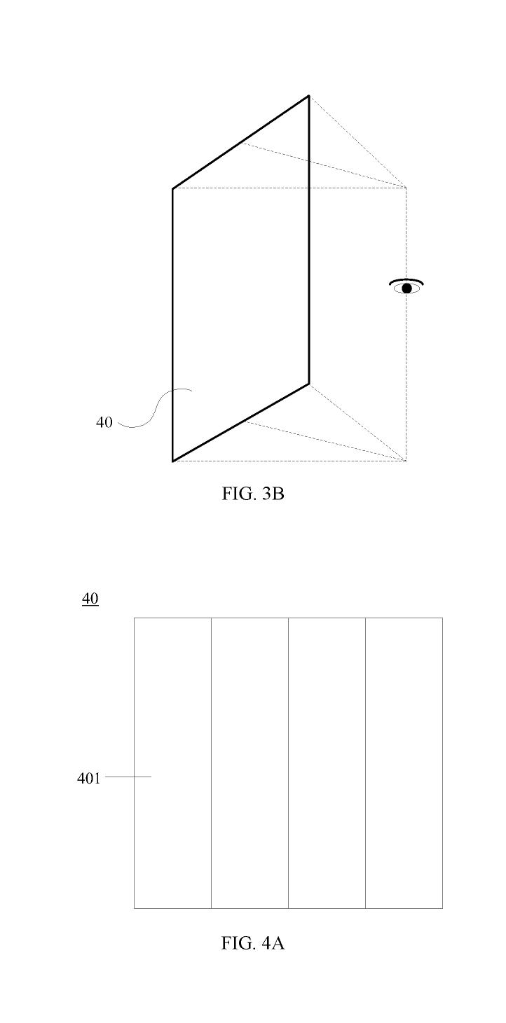

FIGS. 3A and 3B are schematic structural diagrams respectively showing the light-adjusting structure directing an image for a certain viewing angle to a viewing position according to an embodiment of the present disclosure. As shown in FIG. 3A, the viewing position is a point. After being adjusted by the light-adjusting structure 40, the light emitted by the display unit 30 is directed to the point. As shown in FIG. 3B, the viewing position is a position of a vertical line where the position of the human eye is located. After being adjusted by the light-adjusting structure 40, the light emitted by the display unit 30 is directed to the position of the vertical line where the position of the human eye is located. At this case, the light-adjusting unit 40 adjusts only the light emitted by the display unit 30 in the horizontal direction, not in the vertical direction.

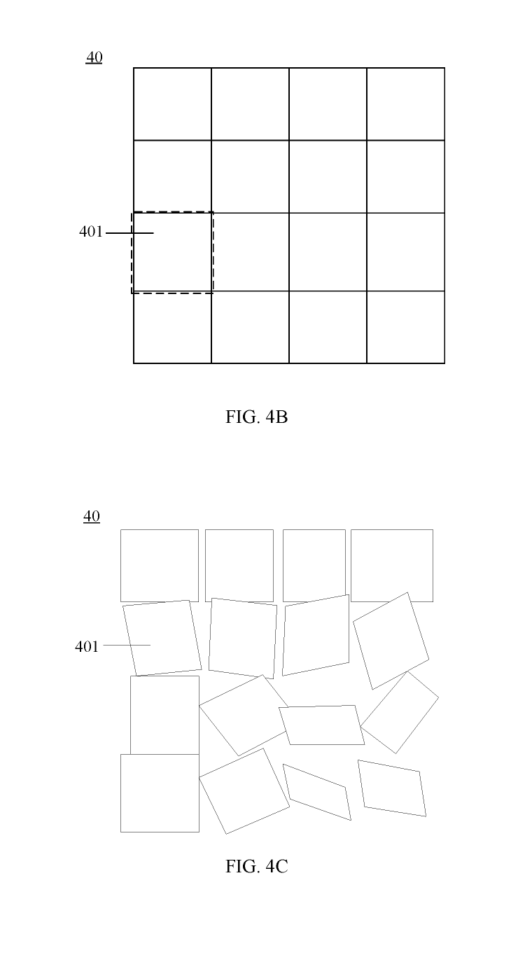

FIGS. 4A, 4B, and 4C respectively show a schematic structural diagram of the light-adjusting structure according to an embodiment of the present disclosure. As shown in FIG. 4A, the light-adjusting structure 40 may include a plurality of strip-shaped light-adjusting units 401 arranged in sequence in the horizontal direction.

As shown in FIG. 4B, the light-adjusting structure 40 may also include a plurality of light-adjusting units 401 arranged in a dot array.

As the light-adjusting structure 40 may be transformed into m different states, the light-adjusting units 401 should also be transformable into a plurality of states. Further, each of the light-adjusting units 401 may independently control the existing direction of the light incident thereon.

It may be understood that the more the number of the light-adjusting units 401, the more precise the light-adjusting structure 40 may direct the image for each viewing angle to the viewing position corresponding to the viewing angle. Further, the number of the light-adjusting units 401 may be the same as the resolution of the image displayed by the display unit 30. For example, in a case where the resolution of the image displayed by the display unit 30 is 1920*1080, the light-adjusting structure 30 may have 1920*1080 light-adjusting units 401. Each light-adjusting unit 401 may adjust light emitted by one pixel. Thereby, the light-adjusting structure 40 may accurately direct the respective image for the respective viewing angle to the viewing position corresponding to the viewing angle.

In an embodiment of the present disclosure, since the light-adjusting structure 40 includes a plurality of light-adjusting units 401 arranged in a dot array, the plurality of light-adjusting units 401 may adjust the light emitted by the display unit 30 into a plurality of directions. Compared with the strip-shaped light-adjusting units 401, the plurality of light-adjusting units 401 arranged in a dot array may adjust the direction of the light emitted by the display unit 30 more precisely, and may adjust that to more directions. Based on this, the plurality of light-adjusting units 401 arranged in a dot array may also adjust the light emitted by the display unit 30 to be directed to one point.

As shown in FIG. 4C, the light-adjusting unit 401 may be a microlens. The microlens may be rotated under the control of the controller 50. The microlens may adjust the existing direction of the light incident thereon.

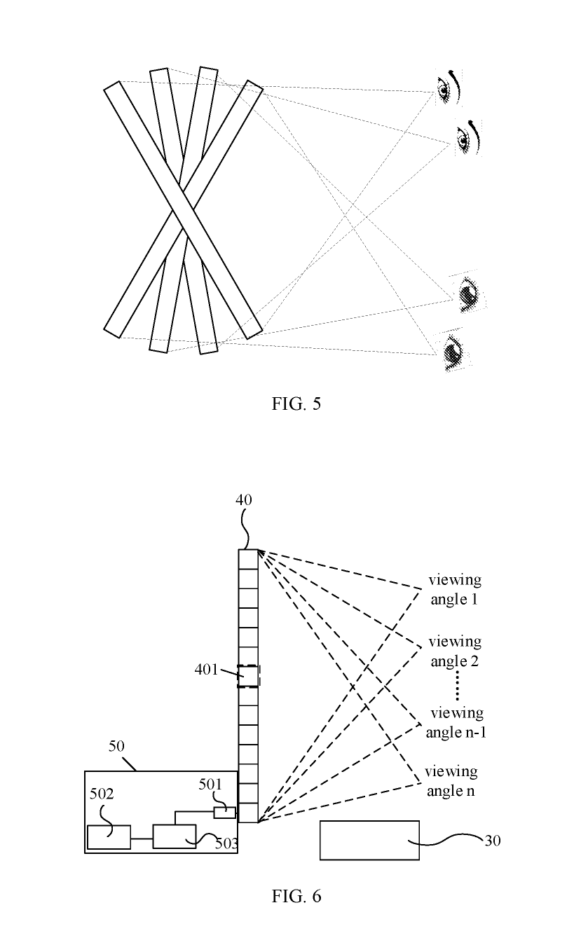

FIG. 5 shows a schematic diagram of changes in states of a microlens according to an embodiment of the present disclosure. Only one microlens is shown schematically in FIG. 5. As shown in FIG. 5, when the angle of the microlens changes, the existing direction of the light also changes accordingly. Only four states of a microlens are illustrated in FIG. 5.

In the embodiment of the present disclosure, it is not limited how the controller 50 controls the rotation of the microlens, as long as the microlens may rotate under the control of the controller 50. The principle of rotation of the microlens controlled by the controller 50 in the embodiment of the present disclosure may be the same as the principle of rotation of a plurality of microlenses on a Digital Micromirror Device (DMD) in Digital Light Processing (DLP). In addition, when the light-adjusting unit 401 is a microlens, in order to ensure that the light-adjusting structure 40 may accurately adjust the light emitted by the display unit 30, the light-adjusting structure 40 may include hundreds or thousands millions of microlenses, and the conversion rate of the microlenses may be at least 1000 times per second.

In the embodiment of the present disclosure, when the light-adjusting unit 401 is a microlens, as the microlens rotates under the control of the controller 50, the state of the microlens may be changed, so that the existing direction of the light incident on the microlens will change. On this basis, the light-adjusting unit 401 provided by the embodiment of the present disclosure has a simple structure and is easy to adjust.

FIG. 6 shows a schematic structural diagram of a display device according to an embodiment of the present disclosure. The display device in FIG. 6 is basically the same in structure as the display device in FIG. 2A. The display device includes a display unit 30, a light-adjusting structure 40, and a controller 50. The controller 50 may include a rotation unit 501, a signal transmission unit 502, and a processing unit 503. Specifically, the rotation unit 501 is coupled (fixedly connected) to the microlens to drive the microlens to rotate. The signal transmission unit 502 may transmit pulse signals having different widths. The processing unit 503 may be coupled (connected) to the signal transmission unit 502 and the rotation unit 501. The processing unit 503 may be configured to convert the pulse signals having different widths into control signals, and may control a direction of rotation and an angle of rotation of the rotation unit 501 according to the control signals.

In the embodiment of the present disclosure, the structure of the rotation unit 501 is not limited, and may be, for example, a hinge means.

Further, it is not limited how the processing unit 503 converts a pulse signal into a control signal for controlling the rotation direction and the rotation angle of the rotation unit 501. For example, the processing unit 503 may include a signal reception unit, a storage unit, and an address electrode. After receiving the pulse signal, the signal reception unit may address the storage unit according to the pulse signal, and activate the address electrode by static electricity, such that the address electrode will cause the rotation unit 501 to rotate. The difference of the pulse signal affects the rotation direction and the rotation angle of the rotation unit 501, which further affects the tilting direction and the tilting angle of the microlens, and also affects the tilting time of the microlens.

Further, a rotation unit 501 may be disposed on each of the microlenses. The signal transmission unit 502 and the processing unit 503 may be disposed on each of the microlenses, and the plurality of signal transmission units 502 and the processing unit 503 may also be integrated together.

In the embodiment of the present disclosure, pulse signals having different widths are transmitted through the signal transmission unit 502. The processing unit 503 processes the pulse signal to provide the control signal, so that the rotation direction and the rotation angle of the rotation unit 501 may be controlled, and thus the tilting direction, the tilting angle, and the tilting time of the microlens may be controlled.

On the other hand, the type of the display unit 30 is not limited. For example, the display unit 30 may be a display panel, or may be a projection device and an image source including image information, and the projection device may project and display the image information provided by the image source.

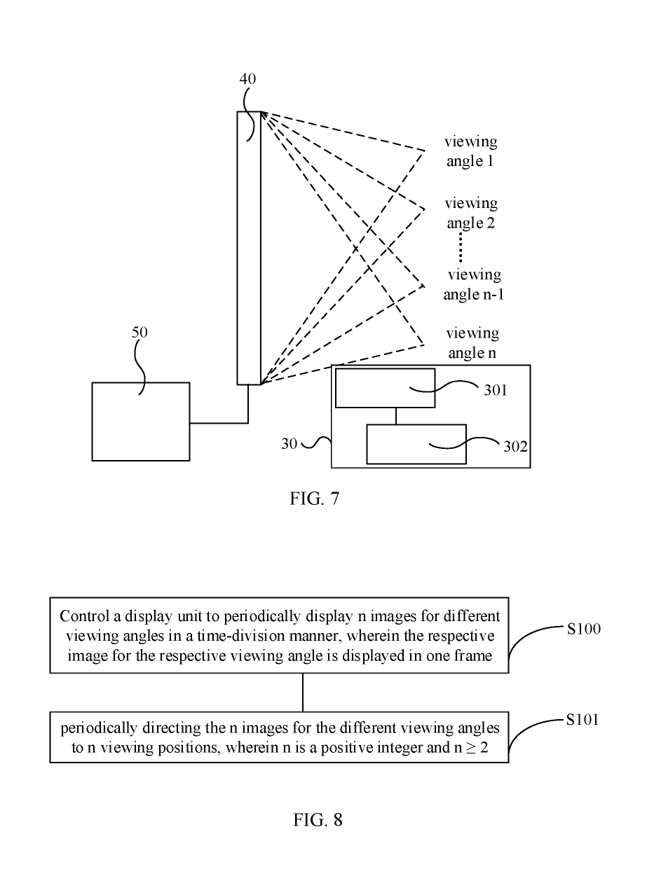

FIG. 7 shows a schematic structural diagram of a display device according to an embodiment of the present disclosure. The display device in FIG. 7 is basically the same in structure as the display device in FIG. 2A. The display device includes a display unit 30, a light-adjusting structure 40, and a controller 50. The display unit 30 includes a projection device 301 and an image source 302. The projection device 301 may be, for example, a projector. In particular, the image source 302 may provide image information to the projection device 301. The projection device 301 is coupled (connected) to the image source 302, and may project the image information provided by the image source 302 onto the light-adjusting structure 40.

In an embodiment of the present disclosure, the image information provided by the image source 302 to the projection device 301 may be image information for different viewing angles.

In addition, after the projection device 301 projects the image information provided by the image source 302 to the light-adjusting structure 40, the light-adjusting structure 40 may adjust the light incident thereon, to input the image information for different viewing angles to different viewing positions.

On the other hand, for one viewer, there may be two viewing positions, which are a left eye viewing position and a right eye viewing position, respectively.

In an embodiment of the present disclosure, n images for different viewing angles may include n/2 sets of images (n is an integer multiple of 2). Each set of images includes two images for different viewing angles displayed in adjacent frames (one viewing angle is in correspondence to the left eye viewing position and the other viewing angle is in correspondence to the right eye viewing position). When the two images for the respective viewing angles displayed in adjacent frames in each set of images include a left eye image and a right eye image for 3D display, the left eye image and the right eye image in each set of images are respectively directed to the left eye viewing position and the right eye viewing position of the same viewer. In this case, the viewer may see the 3D display. When the two images for the respective viewing angles displayed in adjacent frames in each set of images are the same, if the two same images in each set of images are directed to the left eye viewing position and the right eye viewing position of the same viewer, the viewer may see 2D display. On this basis, both 2D display and 3D display can be realized through the display device provided by the embodiment of the present disclosure.

On this basis, the n/2 sets of image, after displayed by the display unit 30 and adjusted by the light-adjusting structure 40, are entirely or partly used for one of 3D display or 2D display. On this basis, when the n/2 sets of images contain a plurality of sets of images for realizing 3D display, the plurality of sets of images for realizing 3D display may be the same or different. If the plurality of sets of images for realizing 3D display are the same, when the plurality of sets of images are displayed and directed to a plurality of viewers, the 3D images viewed by the plurality of viewers are the same. If the plurality of sets of images for realizing 3D display are different, when the plurality of sets of images are displayed and directed to a plurality of viewers, the 3D images viewed by the plurality of viewers are different. Similarly, when the n/2 sets of images contain a plurality of sets of images for realizing 2D display, it is the same as the case of the above 3D display, and details are not described herein again. For example, if the n/2 sets of images contain 2 sets of images for implementing 2D display, one set of images is related to a cartoon, and the other set of images is related to an action movie, if the two sets of images are displayed by the display unit 30 and directed to two viewers (4 viewing angles), the two viewers may simultaneously watch the action movie and the cartoon.

In the embodiment of the present disclosure, the display unit 30 in the display device may display n images for different viewing angles in a time-division manner, and the n images for the different viewing angles may be directed to n viewing positions under the adjustment of the light-adjusting structure 40. Therefore, in the case where the n images for the different viewing angles include the left eye image and the right eye image for 3D display, if the left eye image and the right eye image are respectively directed to the left and right eyes of the same viewer, 3D display may be realized by the display device. Compared with a 3D display technology in which two images for the respective viewing angles are simultaneously displayed in one frame and the two images for the respective viewing angles are respectively directed to a left eye position and a right eye position, since, in the embodiment of the present disclosure, the display unit 30 displays an image for one viewing angle in one frame where the image for one viewing angle is directed to one viewing position, and displays the images for the plurality of viewing angles in a time-division manner, the resolution of the display device is not reduced when performing 3D display.

In an embodiment of the present disclosure, the display device may further include a human eye position recognizer. The human eye position recognizer may acquire the position of the human eye. Herein, it is not limited how to obtain the position of the human eye by the human eye position recognizer. For example, the human eye position recognizer may include a camera and an image processor. The camera may collect an image of the human eye. The image processor may calculate the position of the human eye according to the image of the human eye collected by the camera. In addition, when the camera collects images of a plurality of eyes, the image processor may determine which two of the plurality of eyes are the left and right eyes of the same viewer based on the empirical values of the left and right eyes.

Specifically, the light-adjusting structure 40 may adjust the light emitted by the display unit 30 to the position of the human eye according to the recognized position of the human eye, such that the viewer may view the image displayed by the display unit 30 at a plurality of positions. Generally, for a naked eye 3D display device, the 3D display effect may be seen only at a specific viewing position, so the viewer needs to move to find the best 3D viewing position before viewing. However, in the embodiment of the present disclosure, when the n images for the different viewing angles displayed by the display unit 30 include the left eye image and the right eye image for 3D display, after the human eye position recognizer recognizes the position of the human eye, the light-adjusting structure 40 may adjust the left eye image to be directed to the viewer's left eye, and the right eye image to be directed to the viewer's right eye, so that the viewer does not need to move and may view the 3D display at a plurality of locations.

In the embodiment of the present disclosure, the n images for the different viewing angles include n/2 sets of a left eye image and a right eye image displayed in adjacent frames, and the left eye image and the right eye image in each set of images are respectively directed to the left eye viewing position and the right eye viewing position of the same viewer (n is an integer multiple of 2). Herein, the left eye image and the right eye image are the left eye image and right eye image for 3D display. When the left eye image and the right eye image in each set of images are respectively directed to the left eye viewing position and the right eye viewing position of the same viewer, the viewer may see the 3D display in this case.

In addition, since each set of images may realize 3D display, when n/2 is greater than 1, a plurality of sets of images may realize 3D display in a plurality of positions. Therefore a plurality of viewers may view 3D display. The resolution is not decreased with the increase in the viewing angle. Herein, the n/2 set of images may be the same or different.

The unit described herein may be implemented as a combination of a processor and a memory, where the processor executes the programs stored in the memory to implement the functions of the respective unit. The unit described herein may also be implemented in a complete hardware implementation, including an application specific integrated circuit (ASIC), a field programmable gate array (FPGA), and the like.

FIG. 8 shows a schematic flow chart of a method for controlling a display device according to an embodiment of the present disclosure. As shown in FIG. 8, in the method, in step S100, the control display unit 30 periodically displays n images for different viewing angles in a time-division manner, wherein the respective image for the respective viewing angle is displayed in one frame. In step S101, the n images for the different viewing angles are periodically directed to n viewing positions, where n≥2, n is a positive integer.

In an embodiment of the present disclosure, for one viewer, there may be two viewing positions, which are a left eye viewing position and a right eye viewing position, respectively.

In an embodiment of the present disclosure, the n images for the different viewing angles may include n/2 sets of images (n is an integer multiple of 2). Each set of images includes two images for the different viewing angles displayed in adjacent frames (one viewing angle is correspondence to a left eye viewing position and the other viewing angle is correspondence to a right eye viewing position). When the two images for the different viewing angles displayed in adjacent frames in each set of images include a left eye image and a right eye image for 3D display, the left eye image and the right eye image in each set of images are respectively directed to the left eye viewing position and right eye viewing position of the same viewer, such that the viewer may see the 3D display. When the two images for the different viewing angles displayed in adjacent frames in each set of images are the same, if the two same images in each set of images are directed to the left eye viewing position and the right eye viewing position of the same viewer, the viewer may see 2D display. On this basis, the method for controlling the display device provided by the embodiment of the present disclosure may control the implementation of both 2D display and 3D display.

In an embodiment of the present disclosure, since the display unit 30 in the display device may display n images for the different viewing angles in a time-division manner, and the n images for the different viewing angles may be directed to n viewing positions, when the n images of different viewing angles include the left eye image and the right eye image for 3D display, if the left eye image and the right eye image are respectively directed to the left and right eyes of the same viewer, the display device may realize 3D display. Compared with a 3D display technology in which two images for the respective viewing angles are simultaneously displayed in one frame and the two images of viewing angles are respectively directed to a left eye position and a right eye position, as the display unit 30 of the embodiment of the present disclosure displays an image for one viewing angle in one frame where the image for one viewing angle is directed to one viewing position, and displays the images of the plurality of viewing angles in a time-division manner, the resolution of the display device is not reduced when performing 3D display.

In an embodiment of the present disclosure, the n images of different viewing angles may include n/2 sets of a left eye image and a right eye image displayed in adjacent frames. The method further includes acquiring a left eye viewing position and a right eye viewing position of the viewer, and directing the left eye image and the right eye image in each set of images to the left eye viewing position and the right eye viewing position of the same viewer, respectively.

Here, the left eye image and the right eye image are the left eye image and right eye image for 3D display. When the left eye image and the right eye image in each set of images are respectively directed to the left eye viewing position and the right eye viewing position of the same viewer, the viewer may see the 3D display. In addition, when the positions of a plurality of eyes are acquired, it is possible to determine which two of the plurality of eyes are the left and right eyes of the same viewer based on the empirical values of the left and right eyes.

On this basis, since each set of images may realize 3D display, when n/2 is equal to 1, the set of images displayed by the display unit 30 may only realize 3D display at one position. When n/2 is greater than 1, a plurality of sets of images displayed by the display unit 30 may realize 3D display at a plurality of positions, so that a plurality of viewers may view the 3D display and the resolution does not decrease as the number of viewing angles increases. In addition, the n/2 sets of images may be the same or different. When the n/2 sets of images are the same, the 3D images displayed at the plurality of positions are the same. When the n/2 sets of images are not completely the same, the 3D images displayed at the plurality of positions are not completely the same.

In the embodiment of the present disclosure, the n images for the different viewing angles displayed by controlling the display unit 30 include n/2 sets of a left eye image and a right eye image displayed in adjacent frames, and the left and right eye images in each set of images are controlled to be directed respectively to the left eye viewing position and the right eye viewing position of the same viewer, so that the display device may realize 3D display. Since the respective image for the respective viewing angle is directed to one viewing position, it will not reduce the resolution while realizing 3D display according to the embodiment of the present disclosure. When n/2 is greater than 1, the display device may also implement 3D display at a plurality of locations.

On this basis, since the images of different viewing angles displayed by the display unit 30 may be accurately directed to the left eye viewing position and the right eye viewing position of the same viewer, the viewer may view the image displayed by the display unit 30 at a plurality of positions. Compared with the existing naked eye 3D display device by which the 3D display effect may be seen only at a specific viewing position and hence the viewer needs to move to find an optimal 3D viewing position before viewing, in the embodiment of the present disclosure, when the n images for the different viewing angles displayed by the display unit 30 include a left eye image and a right eye image for 3D display, the viewer does not need to move, and after acquiring the left eye viewing position and the right eye viewing position of the viewer, the left eye image may be adjusted to be directed to the viewer's left eye, and the right eye image may be adjusted to be directed to the viewer's right eye, so that the viewer may view the 3D display at a plurality of locations.

In an embodiment of the present disclosure, the n images for the different viewing angles may include n/2 sets of two same images displayed in adjacent frames. The method further includes acquiring a left eye viewing position and a right eye viewing position of the viewer, and directing the two same images in each set of images to the left eye viewing position and the right eye viewing position of the same viewer, respectively.

Since the two images displayed in adjacent frames in each set of images are the same, when the two same images are respectively directed to the left eye viewing position and the right eye viewing position of the same viewer, the viewer may view 2D display. In addition, when the positions of a plurality of eyes are acquired, it is possible to determine which two of the plurality of eyes are the left and right eyes of the same viewer based on the empirical values of the left and right eyes.

Based on the above, when n/2 is larger than 1, the plurality of sets of images displayed by the display unit 30 may realize 2D display at a plurality of positions, so that a plurality of viewers may see 2D display. In this case, the n/2 set of images may be the same or different. When the n/2 sets of images are the same, the 2D images displayed at the plurality of positions are the same. When the n/2 sets of images are not completely the same, the 2D images displayed at the plurality of positions are not completely the same, so that different viewers may see different content.

It may be understood that the display device provided by the embodiment of the present disclosure, which is the same as the 2D display device in the prior art, may also implement 2D display, when the n images for the different viewing angles displayed by the display unit 30 are not adjusted.

In the embodiment of the present disclosure, the n images for the different viewing angles displayed by controlling the display unit 30 include n/2 sets of two same images displayed in adjacent frames, and the two same images in each set of images are controlled to be respectively directed to the left eye viewing position and the right eye viewing position of the same viewer, so that the display device may realize 3D display.

The above description is only the specific embodiment of the present disclosure, but the scope of the present disclosure is not limited thereto. Any skilled in the art may easily conceive of changes or substitutions within the technical scope of the present disclosure which should be covered within the scope of protection of the present disclosure. Therefore, the scope of protection of the present disclosure should be determined by the scope of the claims.

1. A display device comprising:
a display unit configured to periodically display n images for different viewing angles in a time-division manner, wherein the respective image for the respective viewing angle is displayed in one frame, n is a positive integer, and n≥2;
a light-adjusting structure capable of being transformed into m different states, and configured to adjust, in the respective states, light emitted by the display unit to directions of different viewing positions, wherein m is a positive integer and m>n; and
a controller coupled to the light-adjusting structure and configured to control the light-adjusting structure to be periodically transformed into n different states to periodically direct the n images for the different viewing angles to n viewing positions.

2. The display device according to claim 1, wherein the light-adjusting structure comprises a plurality of light-adjusting units arranged in a dot array.

3. The display device according to claim 2, wherein each light-adjusting unit is a microlens, and wherein the microlens rotates under the control of the controller.

4. The display device according to claim 3, wherein the controller comprises:
a rotation unit fixedly coupled to the microlens and configured to control the rotation of the microlens;
a signal transmission unit configured to transmit pulse signals having different widths; and
a processing unit coupled to the signal transmission unit and the rotation unit, and configured to process the pulse signal into a control signal for controlling a direction of rotation and an angle of rotation of the rotation unit.

5. The display device according to claim 1, wherein the display unit comprises a projection device and an image source;
wherein the image source is configured to provide image information to the projection device; and
wherein the projection device is coupled to the image source and configured to project the image information provided by the image source onto the light-adjusting structure.

6. The display device according to claim 1, wherein the display device further comprises a human eye position recognizer; and
wherein the human eye position recognizer is configured to acquire a human eye position.

7. The display device according to claim 1, wherein the n images for different viewing angles comprise n/2 sets of a left eye image and a right eye image displayed in adjacent frames;
wherein the left eye image and the right eye image in each set are respectively directed to the left eye viewing position and the right eye viewing position of the same viewer; and
wherein n is an integer multiple of 2.

8. A method for controlling a display device, the method comprising:
controlling a display unit to periodically display n images for different viewing angles in a time-division manner, wherein the respective image for the respective viewing angle is displayed in one frame; and
periodically directing the n images for the different viewing angles to n viewing positions, wherein n is a positive integer and n≥2.

9. The method according to claim 8, wherein n is an integer multiple of 2, wherein the n images for the different viewing angles comprise n/2 sets of a left eye image and a right eye image displayed in adjacent frames, and wherein the method further comprises:
acquiring a left eye viewing position and a right eye viewing position of the viewer; and
respectively directing the left eye image and the right eye image in each set to the left eye viewing position and the right eye viewing position of the same viewer.

10. The method according to claim 8, wherein n is an integer multiple of 2, wherein the n images for the different viewing angles comprise n/2 sets of two same images displayed in adjacent frames, and wherein the method further comprises:
acquiring a left eye viewing position and a right eye viewing position of the viewer; and
respectively directing two same images in each set to the left eye viewing position and the right eye viewing position of the same viewer.

11. The display device according to claim 1, wherein the light-adjusting structure is disposed on a light-existing side of the display unit.

12. The display device according to claim 1, wherein the display unit is disposed around the light-adjusting structure, and wherein the light emitted by the display unit is incident on the light-adjusting structure.

13. The display device according to claim 1, wherein the light-adjusting structure comprises a liquid crystal component.

14. The display device according to claim 1, wherein the light-adjusting structure comprises a plurality of strip-shaped light-adjusting units arranged in sequence in a horizontal direction.

15. The display device according to claim 14, wherein a number of the light-adjusting units is the same as a resolution of the image displayed by the display unit.

16. The display device according to claim 4, wherein the rotation unit is disposed on each of the microlenses, and wherein one of i) the signal transmission unit and the processing unit are disposed on each of the microlenses, and ii) a plurality of the signal transmission units and the processing unit are integrated together.
